(19) United States
(12) Patent Application Publication
(10) Pub. No.: US 2026/0051608 A1
(43) Pub. Date: Feb. 19, 2026

(54) BATTERY PACK

(71) Applicant: SK On Co., Ltd., Seoul (KR)

(72) Inventors: So Yeon CHOI, Daejeon (KR); Hyung Ju PAIK, Daejeon (KR); Hae Ryong JEON, Daejeon (KR)

(21) Appl. No.: 19/215,327

(22) Filed: May 22, 2025

(30) Foreign Application Priority Data
Aug. 14, 2024 (KR) 10-2024-0108890

(51) Int. Cl. H01M 50/342; H01M 10/613; H01M 10/6556; H01M 10/658; H01M 50/211; H01M 50/271; H01M 50/367; H01M 50/375

(52) U.S. Cl. CPC H01M 50/3425; H01M 10/613; H01M 10/6556; H01M 10/658; H01M 50/271; H01M 50/367; H01M 50/375; H01M 50/211; H01M 2200/20

(57) ABSTRACT

A battery pack includes a plurality of battery modules, a pack frame supporting the plurality of battery modules, and a pack cover covering the plurality of battery modules. Each of the plurality of battery modules includes a cell assembly including a plurality of battery cells, a module housing accommodating the cell assembly, and a module cover covering the cell assembly and connected to the module housing. The battery pack further includes a first cooling plate disposed between the module housing and the pack frame and configured to accommodate a coolant, and a first venting path at least partially surrounded by the pack frame and the first cooling plate. The first cooling plate is configured to be melted by a gas passing through the first venting path. The coolant is configured to be introduced into the first venting path.

### CROSS-REFERENCE TO RELATED APPLICATION(S)

This patent document claims the priority and benefits of Korean Patent Application No. 10-2024-0108890 filed on Aug. 14, 2024, the disclosure of which is incorporated herein by reference in its entirety.

### TECHNICAL FIELD

The disclosure and implementations disclosed in this patent document generally relate to a battery pack.

### BACKGROUND

Secondary batteries, unlike primary batteries, may be charged with and discharged, and may be applied to devices within various fields such as digital cameras, mobile phones, laptops, hybrid cars, electric cars, and energy storage systems (ESS). Secondary batteries may be lithium-ion batteries, nickel-cadmium batteries, nickel-metal hydride batteries, or nickel-hydrogen batteries.

Secondary batteries are manufactured as flexible pouch-type battery cells or rigid prismatic or cylindrical can-type battery cells. A plurality of battery cells may be disposed inside a cell assembly or a module housing to form a battery module.

### SUMMARY

The battery pack may include a plurality of battery modules, a pack frame accommodating the plurality of battery modules, and a pack cover covering the plurality of battery modules. However, flames, gases, or conductive particles discharged from the battery module may be transmitted to other battery modules, thereby causing thermal runaway.

The present disclosure can be implemented in some embodiments to provide a battery pack capable of delaying thermal propagation between battery modules.

According to an aspect of the present disclosure, a battery pack capable of preventing thermal runaway may be provided.

The battery pack in the present disclosure may be widely applied in green technology fields such as electric vehicles, battery charging stations, and other solar power generation and wind power generation using batteries. In addition, the battery pack in the present disclosure may be used in eco-friendly electric vehicles and hybrid vehicles to prevent climate change by suppressing air pollution and greenhouse gas emissions.

In some embodiments of the present disclosure, a battery pack includes a plurality of battery modules, a pack frame supporting the plurality of battery modules, and a pack cover covering the plurality of battery modules. Each of the plurality of battery modules includes a cell assembly including a plurality of battery cells, a module housing accommodating the cell assembly, and a module cover covering the cell assembly and connected to the module housing. The battery pack further includes a first cooling plate disposed between the module housing and the pack frame and configured to accommodate a coolant, and a first venting path at least partially surrounded by the pack frame and the first cooling plate. The first cooling plate is configured to be melted by a gas passing through the first venting path. The coolant is configured to be introduced into the first venting path.

In an embodiment, each of the plurality of battery cells may include an electrode assembly, a pouch including an electrode receiving portion for accommodating the electrode assembly, and a sealing portion for sealing at least a portion of a periphery of the electrode receiving portion, and an electrode tab connected to the electrode assembly. The sealing portion may include a first sealing portion sealing the electrode tab, and a second sealing portion at least partially folded.

In an embodiment, the plurality of battery cells may include a plurality of first battery cells arranged such that the second sealing portion faces the module housing, and a plurality of second battery cells arranged such that the second sealing portion faces the module cover.

In an embodiment, the module housing may include a first venting portion disposed between the second sealing portions of the plurality of first battery cells and the venting portion may be first venting path. The first configured to rupture based on at least one of a pressure or a temperature inside the module housing.

In an embodiment, the module housing may include a first venting hole disposed between the second sealing portion of the plurality of first battery cells and the first venting path.

In an embodiment, the battery pack may further include a second cooling plate disposed between the module cover and the pack cover and configured to receive a coolant, and a second venting path at least partially surrounded by the pack cover and the second cooling plate. The second cooling plate may be configured to be melted by a gas passing through the second venting path, and the coolant may be configured to flow into the second venting path.

In an embodiment, the module housing may include a second venting portion disposed between the second sealing portion of the plurality of second battery cells and the second venting path. The second venting portion may be configured to rupture based on at least one of a pressure or a temperature inside the module housing.

In an embodiment, the module cover may include a second venting hole disposed between the second sealing portion of the plurality of second battery cells and the second venting path.

In an embodiment, the first cooling plate may include a first plate disposed on one side of the module housing, a second plate joined to the first plate and at least partially folded, and a first coolant receiving space surrounded by the first plate and the second plate and containing the coolant. The second cooling plate may include a third plate disposed on the other side of the module housing, a fourth plate joined to the third plate and at least partially folded, and a second coolant receiving space surrounded by the third plate and the fourth plate and containing the coolant.

In an embodiment, the plurality of first battery cells may be disposed between the second coolant receiving space and the first venting path. The plurality of second battery cells may be disposed between the first coolant receiving space and the second venting path.

In an embodiment, each of the plurality of battery modules may further include a heat dissipation bonding portion including a first heat dissipation bonding portion disposed between the plurality of first battery cells and the module cover, and a second heat dissipation bonding portion disposed between the plurality of second battery cells and the module housing.

In an embodiment, each of the plurality of battery modules may further include an insulating portion disposed between the second sealing portion and the module cover.

In an embodiment, each of the plurality of battery modules may further include an end plate covering a portion of a side surface of the cell assembly. The first venting path may be configured to provide a path through which the gas reflected from the end plate passes.

In an embodiment, the pack frame may further include a bulkhead crossing at least portions of the plurality of battery modules. The bulkhead may include a duct configured to receive the gas from the first venting path.

In an embodiment, the pack frame may further include a pack sidewall surrounding the plurality of battery modules. The pack sidewall may include a duct member configured to receive the gas from the first venting path.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment.

FIG. 2 is a perspective view of a battery module according to an embodiment.

FIG. 3 is an exploded perspective view of a battery pack according to an embodiment.

FIG. 4 is a cross-sectional view taken along line I-I′ of FIG. 4 according to an embodiment.

FIG. 5 is an enlarged view of area A of FIG. 4 in a state where a thermal event has occurred, according to an embodiment.

FIG. 6 is a cross-sectional view taken along line I-I′ of FIG. 4 according to another embodiment.

FIG. 7 is a cross-sectional view taken along line I-I′ of FIG. 4 according to another embodiment.

FIG. 8 is a schematic diagram illustrating gas discharge of a battery pack according to an embodiment.

FIG. 9 is a schematic cross-sectional view of a battery pack according to an embodiment.

### DETAILED DESCRIPTION

Features of the present disclosure disclosed in this patent document are described by example embodiments with reference to the accompanying drawings. However, this is merely illustrative and the present disclosure is not limited to the detailed embodiments described as examples.

The terms or words used in the present specification and claims described below are not to be construed as limited to their conventional or dictionary meanings. The inventor will interpret the terms or words in the sense and concept that are consistent with the technical idea of the present disclosure based on the principle that the inventor may appropriately define the concept of the term to explain his or her own invention in the best way.

Therefore, it will be understood that the embodiments described in this specification and the configurations illustrated in the drawings are only appropriate embodiments of the present disclosure and do not represent all of the technical ideas of the present disclosure, and that there may be various equivalents and modified examples that may replace the same at the time of this application.

Detailed descriptions of known functions and configurations that may obscure the gist of the present disclosure are omitted. In the attached drawings, some components are exaggerated, omitted, or schematically illustrated, and the size of each component does not entirely reflect the actual size.

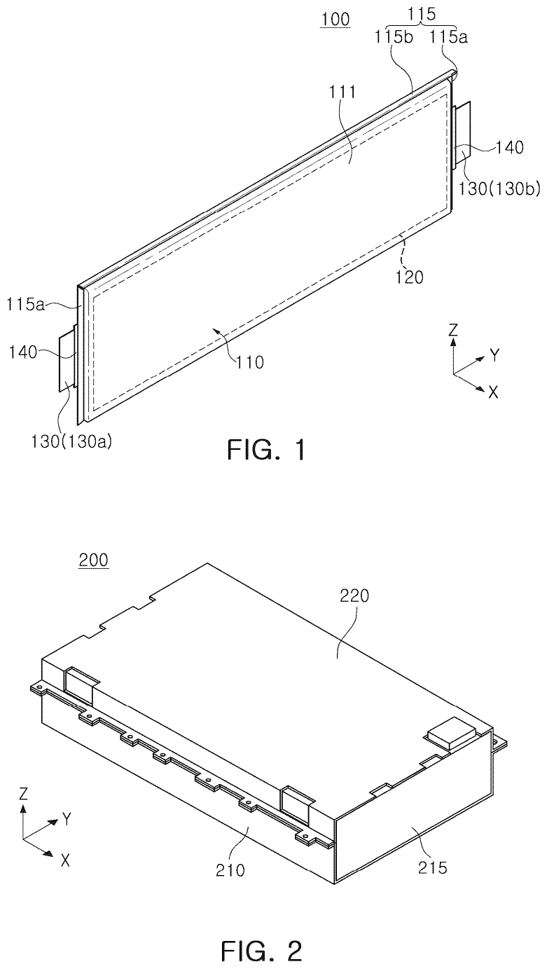

FIG. 1 is a perspective view of a battery cell according to an embodiment.

Referring to FIG. 1, a battery cell 100 may include a pouch 110, an electrode assembly 120, and an electrode tab 130. The battery cell 100 may be a secondary battery. For example, the battery cell 100 may be a lithium ion battery, but is not limited thereto. For example, the battery cell 100 may be a nickel-cadmium battery, a nickel-metal hydride battery, or a nickel-hydrogen battery that may be charged and discharged.

The pouch 110 may form at least a portion of the appearance of the battery cell 100. The pouch 110 may include an electrode receiving portion 111 that accommodates the electrode assembly 120 and a sealing portion 115 for sealing at least a portion of the periphery of the electrode receiving portion 111. The electrode receiving portion 111 may provide a space in which the electrode assembly 120 and the electrolyte are accommodated.

The sealing portion 115 may be formed by joining at least a portion of the periphery of the pouch 110. The sealing portion 115 is formed in a flange shape that extends outward from the electrode receiving portion 111 formed in a container shape, and may be disposed along at least a portion of the outer periphery of the electrode receiving portion 111. In an embodiment, the sealing portion 115 may include a first sealing portion 115a that seals the electrode tab 130 and a second sealing portion 115b that is at least partially folded. The second sealing portion 115b may not seal the electrode tab 130. A portion of the electrode tab 130 may be withdrawn or exposed to the outside of the pouch 110. At the position where the electrode tab 130 is withdrawn, to increase the sealing degree of the first sealing portion 115a and at the same time secure an electrical insulation state, the electrode tab 130 may be covered by an insulating film 140. The insulating film 140 is made of a film material thinner than the electrode tab 130 and may be attached to both sides of the electrode tab 130.

In an embodiment, the electrode tab 130 may be disposed in opposite directions, on both sides of the longitudinal direction of the battery cell 100. For example, the electrode tab 130 may include a cathode tab 130a of a first polarity (for example, cathode) facing one side of the longitudinal direction of the battery cell 100, and an anode tab 130b of a second polarity (for example, anode) facing the other side of the longitudinal direction. In the embodiment illustrated in FIG. 1, the sealing portion 115 may include two first sealing portions 115a in which the electrode tabs 130 are disposed and one second sealing portion 115b in which the electrode tabs 130 are not disposed. The electrode tabs 130 may be referred to as electrode leads.

The direction in which the electrode tab 130 are disposed may be selectively designed. In an embodiment (for example, FIG. 1), the electrode tab 130 may include a cathode tab 130a and an anode tab 130b disposed in an opposite direction to the cathode tab 130a with respect to the electrode assembly 120. In FIG. 1, the electrode tabs 130 are illustrated disposed in opposite directions on both sides of the longitudinal direction of the battery cell 100, but the structure of the electrode tabs 130 is not limited thereto. For example, the two electrode tabs 130 may be arranged substantially parallel along the longitudinal direction of the battery cell 100. Meanwhile, the pouch 110 is not limited to a structure in which a single case is folded to form a sealing portion 115 on three sides as illustrated in FIG. 1.

In an embodiment, at least a portion of the sealing portion 115 may be formed in a form in which it is folded at least once. By folding at least a portion of the sealing portion 115, the bonding reliability of the sealing portion 115 may be improved, and the area of the sealing portion 115 may be significantly reduced. According to an embodiment, among the sealing portions 115, the second sealing portion 115b in which the electrode tab 130 is not disposed may be fixed by an adhesive (not illustrated) after being folded twice. The angle at which the second sealing portion 115b is bent or the number of times it is bent may be changed. For example, in an embodiment not illustrated, the second sealing portion 115b may be folded 90° relative to the first sealing portion 115a.

The electrode assembly 120 may include a cathode plate, an anode plate, and a separator. The separator may prevent contact between the cathode plate and the anode plate. Those skilled in the art will appreciate that the electrode assembly 120 may be manufactured using various methods. According to example embodiments, the cathode, the anode, and the separator may be repeatedly disposed to form the electrode assembly. In some embodiments, the electrode assembly may be a winding type, a stacking type, a Z-fold type, or a stack-folding type.

FIG. 2 is a perspective view of a battery module according to an embodiment.

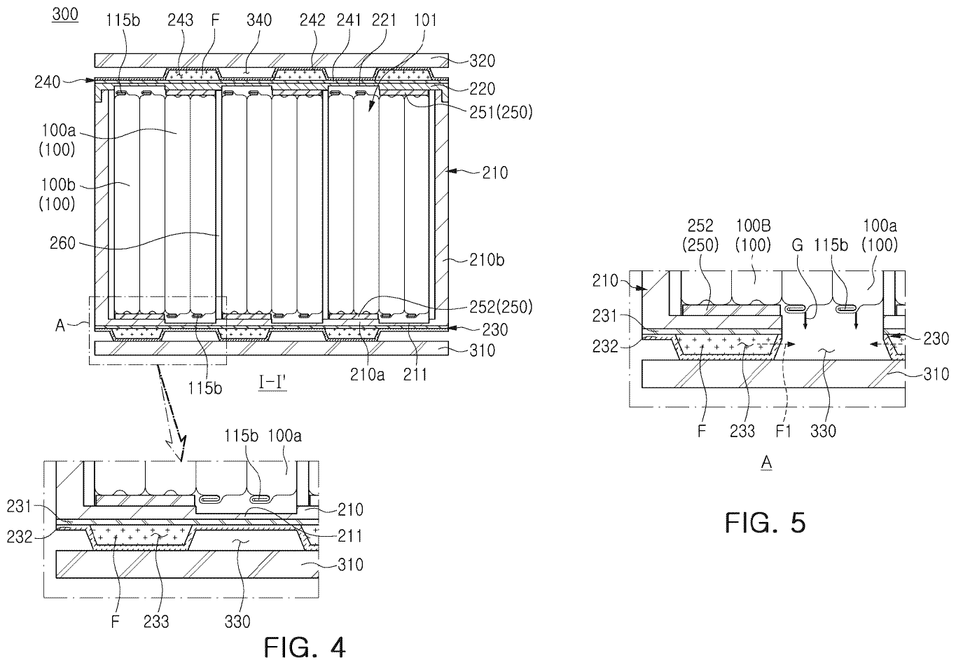

Referring to FIG. 2, a battery module 200 may include a module housing 210, a module cover 220, and an end plate 215. The module housing 210, the module cover 220, and the end plate 215 may form an internal space that accommodates a cell assembly (for example, a cell assembly 101 of FIG. 4) including a plurality of battery cells (for example, a battery cell 100 of FIG. 1).

The module housing 210 may form at least a portion of the exterior of the battery module 200 and may form an internal space that accommodates components of the battery module 200 (for example, the cell assembly 101 and/or a busbar assembly (not illustrated)).

According to an embodiment, the module housing 210 may be made of a material having high thermal conductivity, such as metal. For example, the module housing 210 may be formed of aluminum and/or stainless steel. However, the material of the module housing 210 is not limited thereto. According to another embodiment, the module housing 210 may be formed of polymer. In an embodiment, the module housing 210 may be referred to as a module case.

The module cover 220 may be disposed on one side of the cell assembly 101 and may cover the cell assembly 101. The module cover 220 may form at least a portion of the exterior of the battery module 200. For example, the module cover 220 may be connected to the module housing 210 and may surround at least a portion of the cell assembly.

The end plate 215 may cover a portion of the side of the cell assembly 101. In an embodiment, the end plate 215 may be referred to as a module front cover and/or a module rear cover. In an embodiment, the end plate 215 may be connected to the module housing 210.

The shape of the battery module 200 illustrated in FIG. 2 is illustrative. For example, the shapes of the module housing 210, the module cover 220, and the end plate 215 may be selectively designed.

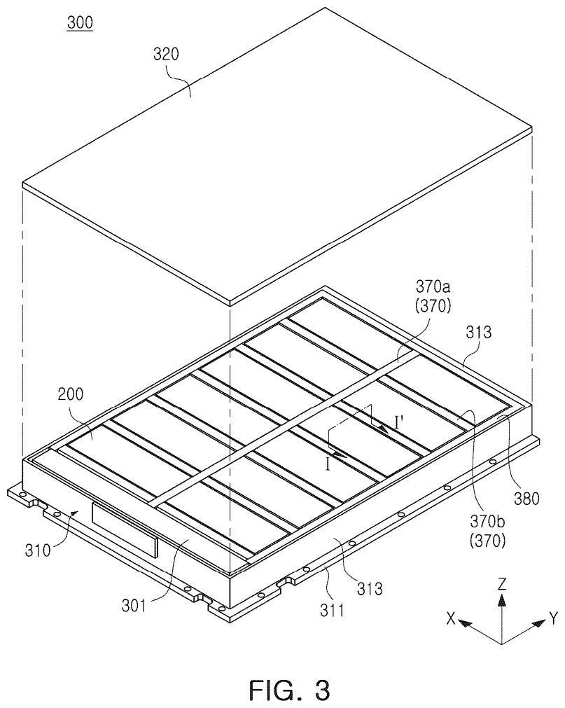

FIG. 3 is an exploded perspective view of a battery pack according to an embodiment.

Referring to FIG. 3, the battery pack 300 may include a plurality of battery modules 200, a pack frame 310 that accommodates the plurality of battery modules 200, and a pack cover 320 that covers the plurality of battery modules 200. The description of the battery module 200 described previously may be applied to the battery module 200 of FIG. 3.

The pack frame 310 may accommodate components (for example, battery modules 200) of the battery pack 300. The pack frame 310 may include a bottom member 311 that supports the battery modules 200. The bottom member 311 may support the battery modules 200. The pack frame 310 may include a pack sidewall 313 that surrounds between at least a portion of the pack cover 320 and the bottom member 311. The pack sidewall 313 may surround a plurality of battery modules 200.

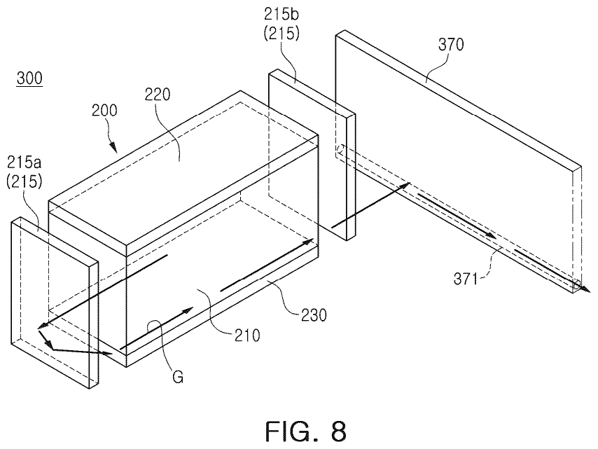

The pack frame 310 may include a bulkhead 370 that crosses at least portions of the plurality of battery modules 200. For example, the accommodation space of the pack frame 310 may be divided into a plurality of spaces by the bulkhead 370. The bulkhead 370 may be installed across the accommodation space to reinforce the rigidity of the pack frame 310. In an embodiment, the bulkhead 370 may include a first bulkhead 370a spanning the plurality of battery cells 100 and a plurality of second bulkheads 370b substantially perpendicular to the first bulkhead 370a. The bulkhead 370 may include a void space (for example, a duct 371 of FIG. 8) through which flames, gases, and/or conductive particles generated in the battery module 200 may flow.

The battery pack 300 may include a battery control unit 301 for controlling the battery module 200. The battery control unit 301 may be disposed within the pack frame 310. The battery control unit 301 may include a battery management system (BMS). The configuration of the battery control unit 301 is known in various forms, so a detailed description thereof will be omitted. In an embodiment, the battery control unit 301 may be referred to as a processor.

In an embodiment, the pack frame 310 of the battery pack 300 may include a duct member 380. The duct member 380 may include an exhaust space for providing a path for gas and/or flame discharged from the battery module 200. In an embodiment, the duct member 380 may be a part of the pack sidewall 313. Gas and/or flames generated from the battery cell of the battery module 200 (for example, from the battery cell 100 of FIG. 1) may be transmitted to the outside of the battery pack 300 through the exhaust space of the duct member 380. In the present disclosure, the duct member 380 may be referred to as an exhaust duct or an exhaust member.

The structure of the battery pack 300 of FIG. 3 is illustrative. For example, the number of battery modules 200 included in the battery pack 300, the structure of the pack frame 310 and/or the duct member 380 may be selectively designed.

FIG. 4 is a cross-sectional view taken along line I-I′of FIG. 4 according to an embodiment. FIG. 5 is an enlarged view of area A of FIG. 4 in a state where a thermal event has occurred according to an embodiment.

Referring to FIGS. 4 and 5, the battery pack 300 may include a plurality of battery modules 200, a pack frame 310, a pack cover 320, and a first cooling plate 230. At least some of the descriptions of the battery cell 100, the battery module 200, and the battery pack 300 of FIGS. 1, 2, and/or 3 may be applied to the battery cell 100, the battery module 200, and the battery pack 300 of FIGS. 4 and/or 5.

The plurality of battery modules 200 may each include a cell assembly 101, a module housing 210, and a module cover 220.

The cell assembly 101 may include a plurality of battery cells 100. The plurality of battery cells 100 may be arranged staggered relative to each other. For example, the plurality of battery cells 100 may include a plurality of first battery cells 100a arranged with the second sealing portion 115b toward the module housing 210 and a plurality of second battery cells 100b arranged with the second sealing portion 115b toward the module cover 220.

The module housing 210 may accommodate a cell assembly 101. For example, the module housing 210 may include a support portion 210a that supports the cell assembly 101 and a module sidewall 210b extended from the support portion 210a. The module sidewall 210b may cover both sides of the cell assembly 101.

The module housing 210 may include a first venting portion 211. The first venting portion 211 may provide a path for gas, flame, and/or conductive particles generated in the cell assembly 101 to be discharged to the outside of the battery module 200. The first venting portion 211 may be located between the second sealing portion 115b of the plurality of first battery cells 100a and the first venting path 330. For example, the first venting portion 211 may face the second sealing portion 115b of the first battery cell 100a. A substance (for example, gas) discharged from the second sealing portion 115b of the first battery cell 100a may be transferred to the first venting portion 211.

The first venting portion 211 may be ruptured based on at least one of the pressure or temperature inside the module housing 210. For example, the first venting portion 211 may have a notching or half-cut shape. The thickness of the first venting portion 211 may be thinner than the thickness of another portion (for example, the support portion 210a) of the module housing 210.

The module cover 220 may cover the cell assembly 101. The module cover 220 may be connected to the module housing 210. For example, the module cover 220 may be welded or joined to the module sidewall 210b of the module housing 210.

The module cover 220 may include a second venting portion 221. The second venting portion 221 may provide a path for gas, flame, and/or conductive particles generated in the cell assembly 101 to be discharged to the outside of the battery module 200. The second venting portion 221 may be located between the second sealing portion 115b of the plurality of second battery cells 100b and the second venting path 340. For example, the second venting portion 221 may face the second sealing portion 115b of the second battery cell 100b. A substance (for example, gas) discharged from the second sealing portion 115b of the second battery cell 100b may be transferred to the second venting portion 221.

The second venting portion 221 may be ruptured based on at least one of the pressure or temperature inside the module housing 210. For example, the second venting portion 221 may have a notching or half-cut shape. The thickness of the second venting portion 221 may be thinner than the thickness of other parts of the module cover 220.

The first cooling plate 230 may cool the cell assembly 101. The first cooling plate 230 may accommodate a coolant F. At least a portion of the heat generated from the battery cell 100 may be transferred to the first cooling plate 230. The first cooling plate 230 may include a first coolant receiving space 233 that receives a coolant F. At least a portion of the heat generated from the battery cell 100 may be transferred to the coolant F flowing through the first coolant receiving space 233. In an embodiment, the coolant F may be a coolant.

The coolant F may be supplied by a first tank located inside the battery pack 300, or a second tank located outside the battery pack 300 (for example, in a vehicle). For example, the battery pack 300 may include an inlet and an outlet for the circulation of the coolant F.

The first cooling plate 230 may be located on one side (for example, on the lower portion) of the battery module 200. For example, the first cooling plate 230 may be disposed between the module housing 210 and the pack frame 310.

The first cooling plate 230 may include a plurality of plates 231 and 232. For example, the first cooling plate 230 may include a first plate 231 disposed on one side of the module housing 210 and a second plate 232 joined (for example, brazed) to the first plate 231. The first coolant receiving space 233 is surrounded by the first plate 231 and the second plate 232 and may receive coolant F. At least a portion of the second plate 232 may have a bent shape or a stepped shape.

The battery pack 300 may include a first venting path 330 configured to allow gas, flame, and/or conductive particles generated from the battery cells 100 to flow. At least a portion of the first venting path 330 may be surrounded by the pack frame 310 and the first cooling plate 230. For example, the first venting path 330 may be an empty space defined by the upper portion of the pack frame 310 and the second plate 232 of the first cooling plate 230.

In an embodiment, the first cooling plate 230 may be connected to the pack frame 310. For example, the first cooling plate 230 may be bonded to the pack frame 310. In another example, the first cooling plate 230 may be coupled to the pack frame 310 using a fastening member.

The first venting path 330 may transmit gas, flame, and/or conductive particles to the outside of the battery pack 300. For example, the first venting path 330 may be connected to the bulkhead 370 and/or the pack sidewall 313 of FIG. 3. A substance (for example, gas) passing through the first venting path 330 may be transmitted to the bulkhead 370 or the pack sidewall 313 (for example, duct member 380). The first venting path 330 may be located on one side of the battery module 200.

The first cooling plate 230 may be melted by the gas passing through the first venting path 330. The coolant F may be introduced into the first venting path 330. For example, when the first cooling plate 230 is melted, the coolant F flowing inside the first coolant receiving space 233 of the first cooling plate 230 may flow into the first venting path 330. When the coolant F is transferred to the first venting path 330, the temperature of a material passing through the first venting path 330 is reduced, and heat transfer between the battery cells 100 or the battery modules 200 may be delayed. In an embodiment, the cooling plates 230 and 240 may be manufactured from a material having a lower melting point than the module housing 210 and/or the module cover 220.

The second cooling plate 240 may cool the cell assembly 101. The second cooling plate 240 may accommodate a coolant F. At least a portion of the heat generated from the battery cell 100 may be transferred to the second cooling plate 240. The second cooling plate 240 may include a second coolant receiving space 243 that accommodates the coolant F. At least a portion of the heat generated from the battery cell 100 may be transferred to the coolant F flowing in the second coolant receiving space 243. In an embodiment, the coolant F may be coolant.

The second cooling plate 240 may be located on the other side (for example, the upper portion) of the battery module 200. For example, the second cooling plate 240 may be located between the module cover 220 and the pack cover 320. The cell assembly 101 may be disposed between the first cooling plate 230 and the second cooling plate 240.

The second cooling plate 240 may include a plurality of plates 241 and 242. For example, the second cooling plate 240 may include a third plate 241 disposed on the other side (for example, the upper portion) of the module housing 210 and a fourth plate 242 joined (for example, brazed) to the third plate 241. The second coolant receiving space 243 is surrounded by the third plate 241 and the fourth plate 242 and may receive coolant F. At least a portion of the fourth plate 242 may have a bent shape or a stepped shape.

The battery pack 300 may include a second venting path 340 configured to allow gas, flames, and/or conductive particles generated from the battery cells 100 to flow. At least a portion of the second venting path 340 may be surrounded by the pack cover 320 and the second cooling plate 240. For example, the second venting path 340 may be an empty space defined by the fourth plate 244 of the pack cover 320 and the second cooling plate 240.

In an embodiment, the second cooling plate 240 may be connected to the pack cover 320. For example, the second cooling plate 240 may be bonded to the pack cover 320. As another example, the second cooling plate 240 may be coupled to the pack cover 320 using a fastening member.

The second venting path 340 may transmit gas, flames, and/or conductive particles to the outside of the battery pack 300. For example, the second venting path 340 may be connected to the bulkhead 370 and/or the pack sidewall 313 of FIG. 3. A substance (for example, gas) passing through the second venting path 340 may be transmitted to the bulkhead 370 or the pack sidewall 313 (for example, duct member 380). The second venting path 340 may be located on the other side of the battery module 200. For example, the battery module 200 may be located between the first venting path 330 and the second venting path 340.

The second cooling plate 240 may be melted by the gas passing through the second venting path 340. The coolant F may be introduced into the second venting path 340. For example, as the second cooling plate 240 is melted, the coolant F flowing inside the second coolant receiving space 243 of the second cooling plate 240 may be introduced into the second venting path 340. As the coolant F is transferred to the second venting path 340, the temperature of the material passing through the second venting path 340 may be reduced, and heat transfer between the battery cells 100 or the battery modules 200 may be delayed.

In an embodiment, each of the plurality of battery modules 200 may include a barrier 260. The cell assembly 101 may include a barrier 260. The barrier 260 may be located between at least some of the plurality of battery cells 100. The barrier 260 may delay heat transmission between the plurality of battery cells 100. For example, the barrier 260 may be made of a flame retardant and heat resistant material, such as mica. In an embodiment, the barrier 260 may be referred to as a thermal barrier. In an embodiment, the barrier 260 may include a compression pad configured to deform based on the expansion of the battery cell 100.

In an embodiment, each of the plurality of battery modules 200 may include a heat dissipation bonding portion 250 that attaches the battery cell 100 to the module housing 210 or the module cover 220.

In an embodiment, the heat dissipation bonding portion 250 may include a first heat dissipation bonding portion 251 disposed between the plurality of first battery cells 100a and the module cover 220, and a second heat dissipation bonding portion 252 disposed between the plurality of second battery cells 100b and the module housing 210. At least a portion of the heat generated from the first battery cells 100a may be transferred to the module cover 220 through the first heat dissipation bonding portion 251. At least a portion of the heat generated from the second battery cells 100b may be transferred to the module housing 210 through the second heat dissipation bonding portion 252. In an embodiment, the heat dissipation bonding portion 250 may be a thermal adhesive.

The battery cell 100 may be disposed between the coolant receiving space 233, 243 and the venting paths 330 and 340. For example, a plurality of first battery cells 100a may be disposed between the second coolant receiving space 243 and the first venting path 330, and a plurality of second battery cells 100b may be disposed between the first coolant receiving space 233 and the second venting path 340. At least a portion of the heat generated from the first battery cell 100a may be transferred to the module cover 220 through the first heat dissipation bonding portion 251. At least a portion of the gas generated from the first battery cell 100a may be transferred to the first venting path 330 through the first venting portion 211. At least a portion of the heat generated from the second battery cell 100b may be transferred to the module housing 210 through the second heat dissipation bonding portion 252. At least a portion of the gas generated from the second battery cell 100b may be transferred to the second venting path 340 through the second venting portion 221.

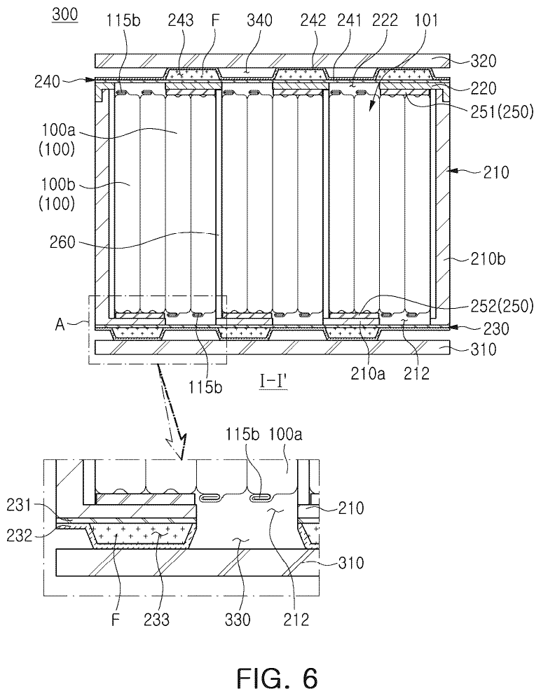

FIG. 6 is a cross-sectional view taken along line I-I′ of FIG. 4 according to another embodiment.

Referring to FIG. 6 together with FIGS. 4 and 5, a plurality of battery modules 200, a first cooling plate 230, a second cooling plate 240, a pack frame 310, a pack cover 320, a first venting path 330, and/or a second venting path 340 may be included. Each of the plurality of battery modules 200 may include a cell assembly 101, a module housing 210, and a module cover 220. At least some of the descriptions of the battery cell 100, the battery module 200, and the battery pack 300 of FIGS. 4 and 5 may be applied to the battery cell 100, the battery module 200, and the battery pack 300 of FIG. 6.

The module housing 210 may include a first venting hole 212. The first venting hole 212 may provide a path for gas, flames, and/or conductive particles generated in the cell assembly 101 to be discharged to the outside of the battery module 200. The first venting hole 212 may be located between the second sealing portion 115b of the plurality of first battery cells 100a and the first venting path 330. For example, the first venting hole 212 may face the second sealing portion 115b of the first battery cell 100a. A substance (for example, gas) discharged from the second sealing portion 115b of the first battery cell 100a may be delivered to the first venting hole 212. The first venting hole 212 may be a through hole formed in the module housing 210. The gas passing through the first venting hole 212 may be delivered to the first venting path 330. In an embodiment, the first cooling plate 230 may be melted by the gas passing through the first venting hole 212 and/or the gas passing through the first venting path 330. As the first cooling plate 230 is melted, the coolant F flowing inside the first coolant receiving space 233 of the first cooling plate 230 may be introduced into the first venting path 330. As the coolant F is transferred to the first venting path 330, the temperature of the material passing through the first venting path 330 is reduced, and heat transfer between the battery cells 100 or the battery modules 200 may be delayed.

In an embodiment (not illustrated), the first cooling plate 230 may include a through hole formed at a position corresponding to the first venting hole 212. For example, gas generated in the first battery cell 100a may be transferred to the first venting path 330 through the first venting hole 212 of the module housing 210 and the through hole of the first cooling plate 230.

The module cover 220 may include a second venting hole 222. The second venting hole 222 may provide a path for gases, flames, and/or conductive particles generated in the cell assembly 101 to be discharged to the outside of the battery module 200. The second venting hole 222 may be located between the second sealing portions 115b of the plurality of second battery cells 100b and the second venting path 340. For example, the second venting hole 222 may face the second sealing portions 115b of the second battery cells 100b. A substance (for example, gas) discharged from the second sealing portions 115b of the second battery cells 100b may be transferred to the second venting hole 222. The second venting hole 222 may be a through hole formed in the module cover 220.

In an embodiment, the second cooling plate 240 may be melted by the gas passing through the second venting hole 222 and/or the gas passing through the second venting path 340. As the second cooling plate 240 is melted, the coolant F flowing inside the second coolant receiving space 243 of the second cooling plate 240 may be introduced into the second venting path 340. As the coolant F is transferred to the second venting path 340, the temperature of the material passing through the second venting path 340 may be reduced, and heat transfer between the battery cells 100 or the battery modules 200 may be delayed.

In an embodiment (not illustrated), the second cooling plate 240 may include a through hole formed at a location corresponding to the second venting hole 222. For example, gas generated from the second battery cell 100b may be delivered to the second venting path 340 through the second venting hole 222 of the module cover 220 and the through hole of the second cooling plate 240.

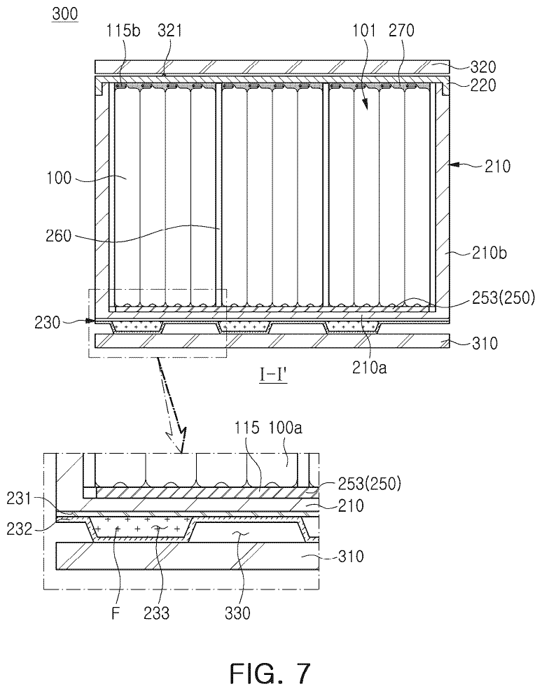

FIG. 7 is a cross-sectional view taken along line I-I′ of FIG. 4 according to another embodiment. FIG. 8 is a schematic diagram illustrating gas discharge of a battery pack according to an embodiment.

Referring to FIGS. 7 and 8, a plurality of battery modules 200, a pack frame 310, a pack cover 320, and a first venting path 330 may be included. Each of the plurality of battery modules 200 may include a cell assembly 101, a module housing 210, a module cover 220, and a first cooling plate 230. At least some of the descriptions of the battery module 200 and the battery pack 300 of FIGS. 2, 3, and/or 4 may be applied to the battery cell 100, the battery module 200, and the battery pack 300 of FIGS. 7 and/or 8. For example, the battery module 200 may include a cell assembly 101, a module housing 210, a module cover 220, a heat dissipation bonding portion 250, and a barrier 260.

The cell assembly 101 may include a plurality of battery cells 100. The plurality of battery cells 100 may include a plurality of first battery cells 100a arranged such that the second sealing portion 115b faces the module cover 220, and may not include a second battery cell (for example, the second battery cell 100b of FIG. 4) arranged such that the second sealing portion 115b faces the module housing 210.

Each of the plurality of battery modules 200 may include an insulating portion 270 disposed between the second sealing portion 115b and the module cover 220. The insulating portion 270 may be disposed between the battery cell 100 and the module cover 220. The insulating portion 270 may seal and insulate the battery cell 100. The insulating portion 270 may include a ceramic wool and/or a mica sheet.

Each of the plurality of battery modules 200 may include a heat dissipation bonding portion 250. The heat dissipation bonding portion 250 may include a third heat dissipation bonding portion 253 disposed between the plurality of battery cells 100 and the module housing 210.

The battery module 200 may not include a venting portion (for example, the venting portions 211 and 221 of FIG. 4) and/or a venting hole (for example, the venting holes 212 and 222 of FIG. 6). For example, gas, flames, and/or conductive particles generated in the battery cell 100 may be discharged to the outside of the battery cell 100 through the electrode tab (for example, the electrode tab 130 of FIG. 1) of the battery cell 100. At least a portion of the gas G discharged from the battery cell 100 may be reflected on the end plate 215 of the battery module 200. For example, the end plate 215 may include a front cover 215a located on one side of the module housing 210 and a rear cover 215b located on the other side of the module housing 210. The gas G discharged from the battery cell 100 may be transmitted to the first venting path 330 after being reflected on the front cover 215a.

The first venting path 330 may be an empty space formed by the cooling plate 230 and the pack frame 310. At least a portion of the first cooling plate 230 may be melted by the gas G passing through the first venting path 330. As the first cooling plate 230 is melted, the coolant F flowing inside the first coolant receiving space 233 of the first cooling plate 230 may flow into the first venting path 330. As the coolant F is transferred to the first venting path 330, the temperature of a substance (for example, gas G) passing through the first venting path 330 is reduced, and heat transfer between battery cells 100 or battery modules 200 may be delayed.

The first venting path 330 may provide a path through which gas G reflected from the end plate 215 passes. The bulkhead 370 may include a duct 371 configured to receive gas G from the first venting path 330. The duct 371 may be an empty space located inside the bulkhead 370. The gas G passing through the first venting path 330 may be delivered to the duct 371 of the bulkhead 370. The duct 371 of the bulkhead 370 may face the first venting path 330. In an embodiment (not illustrated), the gas G passing through the first venting path 330 may be delivered to a pack sidewall (for example, a pack sidewall 313 of FIG. 3). The pack sidewall 313 may include a duct member (for example, a duct member 380 of FIG. 3) configured to receive gas G from the first venting path 330. The gas G passing through the first venting path 330 may be delivered to the duct member 380. The duct member 380 may face the first venting path 330.

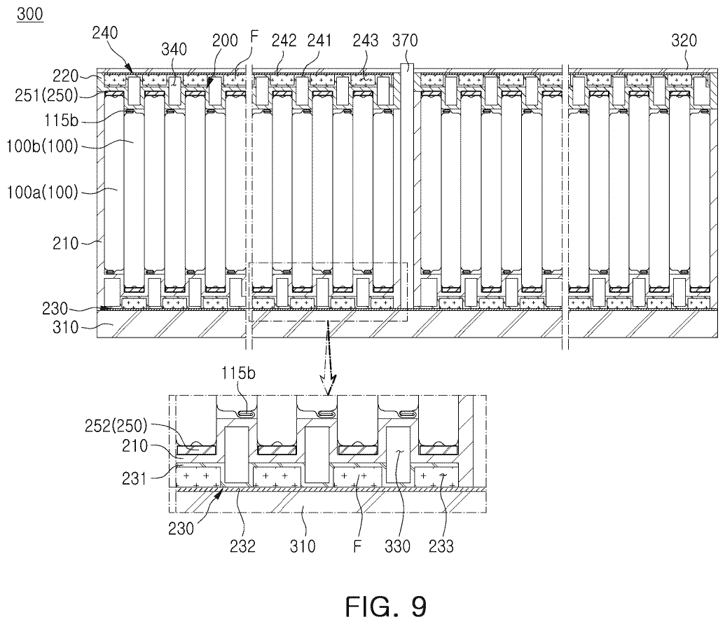

FIG. 9 is a schematic cross-sectional view of a battery pack according to an embodiment.

Referring to FIG. 9, the battery pack 300 may include a plurality of battery modules 200, a pack frame 310, and a pack cover 320. The battery pack 300 may include a plurality of battery modules 200, a first cooling plate 230, a second cooling plate 240, a pack frame 310, a pack cover 320, a first venting path 330, and/or a second venting path 340. Each of the plurality of battery modules 200 may include a cell assembly 101, a module housing 210, and a module cover 220. At least some of the descriptions of the battery cell 100, the battery module 200, and the battery pack 300 of FIGS. 4 and 5 may be applied to the battery cell 100, the battery module 200, and the battery pack 300 of FIG. 9.

The battery module 200 may include a plurality of battery cells 100. The plurality of battery cells 100 may be arranged staggered relative to each other. For example, the plurality of battery cells 100 may include a plurality of first battery cells 100a arranged with the second sealing portion 115b facing the module housing 210 and a plurality of second battery cells 100b arranged with the second sealing portion 115b facing the module housing 210.

In an embodiment, the plurality of battery cells 100 may be arranged to have different heights. For example, the first battery cell 100a may be disposed higher than the second battery cell 100b. The first battery cell 100a may be disposed closer to the module cover 220 and/or the pack cover 320 than the second battery cell 100b. By arranging the first battery cell 100a and the second battery cell 100b to have different heights, the gas discharge efficiency through the venting paths 330 and 340 may be improved.

In an embodiment, the module housing 210 and/or the module cover 220 may be formed based on the arrangement of the battery cell 100. For example, the module housing 210 and/or the module cover 220 may be formed so that at least a portion is bent. The shapes of the module housing 210 and the module cover 220 illustrated in FIG. 9 are illustrative.

The module housing 210 may include the first venting portion 211 of FIG. 4 or the first venting hole 212 of FIG. 6. The module cover 220 may include the second venting portion 221 of FIG. 6 or the second venting hole 222 of FIG. 6.

The first cooling plate 230 may include a plurality of plates 231, 232. For example, the first cooling plate 230 may include a first plate 231 disposed on one side of the module housing 210 and a second plate 232 connected (for example, brazed) to the first plate 231. The first cooling plate 230 may be formed to correspond to the shape of the module housing 210. For example, at least a portion of the first plate 231 may have a folded shape or a stepped shape. The empty space between the first plate 231 and the second plate 232 may be the first coolant receiving space 233.

The second cooling plate 240 may include a plurality of plates 431 and 242. For example, the second cooling plate 240 may include a third plate 241 disposed on one side of the module cover 220 and a fourth plate 242 connected (for example, brazed) to the third plate 241. The second cooling plate 240 may be formed to correspond to the shape of the module cover 220. For example, at least a portion of the fourth plate 242 may have a folded shape or a stepped shape. The empty space between the third plate 241 and the fourth plate 242 may be the second coolant receiving space 233.

As set forth above, according to an embodiment, heat propagation between multiple battery modules may be delayed.

According to an embodiment, thermal runaway of a battery pack may be prevented.

The above description is merely an example of applying the principles of the present disclosure, and other configurations may be further included without departing from the scope of the present disclosure.

Only specific examples of implementations of certain embodiments are described. Variations, improvements and enhancements of the disclosed embodiments and other embodiments may be made based on the disclosure of this patent document.

What is claimed is:

1. A battery pack comprising:
a plurality of battery modules;
a pack frame supporting the plurality of battery modules; and
a pack cover covering the plurality of battery modules,
wherein each of the plurality of battery modules includes,
a cell assembly including a plurality of battery cells;
a module housing accommodating the cell assembly; and
a module cover covering the cell assembly and connected to the module housing,
wherein the battery pack further includes a first cooling plate disposed between the module housing and the pack frame and configured to accommodate a coolant; and a first venting path at least partially surrounded by the pack frame and the first cooling plate,
wherein the first cooling plate is configured to be melted by a gas passing through the first venting path, and
the coolant is configured to be introduced into the first venting path.

2. The battery pack of claim 1, wherein each of the plurality of battery cells includes an electrode assembly, a pouch including an electrode receiving portion for accommodating the electrode assembly, and a sealing portion for sealing at least a portion of a periphery of the electrode receiving portion, and an electrode tab connected to the electrode assembly,
wherein the sealing portion includes a first sealing portion sealing the electrode tab, and a second sealing portion at least partially folded.

3. The battery pack of claim 2, wherein the plurality of battery cells include,
a plurality of first battery cells arranged such that the second sealing portion faces the module housing, and
a plurality of second battery cells arranged such that the second sealing portion faces the module cover.

4. The battery pack of claim 3, wherein the module housing includes a first venting portion disposed between the second sealing portion of the plurality of first battery cells and the first venting path,
wherein the first venting portion is configured to rupture based on at least one of a pressure or a temperature inside the module housing.

5. The battery pack of claim 3, wherein the module housing includes a first venting hole disposed between the second sealing portion of the plurality of first battery cells and the first venting path.

6. The battery pack of claim 3, further comprising:
a second cooling plate disposed between the module cover and the pack cover and configured to receive a coolant; and
a second venting path at least partially surrounded by the pack cover and the second cooling plate,
wherein the second cooling plate is configured to be melted by a gas passing through the second venting path, and
the coolant is configured to flow into the second venting path.

7. The battery pack of claim 6, wherein the module cover includes a second venting portion disposed between the second sealing portion of the plurality of second battery cells and the second venting path,
wherein the second venting portion is configured to rupture based on at least one of a pressure or a temperature inside the module housing.

8. The battery pack of claim 6, wherein the module cover includes a second venting hole disposed between the second sealing portion of the plurality of second battery cells and the second venting path.

9. The battery pack of claim 6, wherein the first cooling plate includes a first plate disposed on one side of the module housing, a second plate joined to the first plate and at least partially folded, and a first coolant receiving space surrounded by the first plate and the second plate and containing the coolant, and
the second cooling plate includes a third plate disposed on the other side of the module housing, a fourth plate joined to the third plate and at least partially folded, and a second coolant receiving space surrounded by the third plate and the fourth plate and containing the coolant.

10. The battery pack of claim 9, wherein the plurality of first battery cells are disposed between the second coolant receiving space and the first venting path, and
the plurality of second battery cells are disposed between the first coolant receiving space and the second venting path.

11. The battery pack of claim 3, wherein each of the plurality of battery modules further includes a heat dissipation bonding portion including a first heat dissipation bonding portion disposed between the plurality of first battery cells and the module cover, and a second heat dissipation bonding portion disposed between the plurality of second battery cells and the module housing.

12. The battery pack of claim 2, wherein each of the plurality of battery modules further includes an insulating portion disposed between the second sealing portion and the module cover.

13. The battery pack of claim 1, wherein each of the plurality of battery modules further includes an end plate covering a portion of a side surface of the cell assembly, and
the first venting path is configured to provide a path through which the gas reflected from the end plate passes.

14. The battery pack of claim 1, wherein the pack frame further includes a bulkhead crossing at least portions of the plurality of battery modules,
wherein the bulkhead includes a duct configured to receive the gas from the first venting path.

15. The battery pack of claim 1, wherein the pack frame further includes a pack sidewall surrounding the plurality of battery modules,
wherein the pack sidewall includes a duct member configured to receive the gas from the first venting path.
